(19) United States
(12) Patent Application Publication
(10) Pub. No.: US 2003/0095145 A1
(43) Pub. Date: May 22, 2003

(54) System and method for table row selection in a GUI display

(76) Inventors: Jonathan Patrizio, San Francisco, CA (US); Eric Soderberg, Mountain View, CA (US)

Correspondence Address: HEWLETT-PACKARD COMPANY, Intellectual Property Administration, P.O. Box 272400, Fort Collins, CO, 80527-2400, US

(21) Appl. No.: 09/984,368

(22) Filed: Oct. 30, 2001

(51) Int. Cl. G09G 5/00

(52) U.S. Cl. 345/764

(57) ABSTRACT

A mechanism for displaying a layout of graphic user interface properties in a panel. The generic mechanism defines the layout of interrelated object properties, where the layout of similar panels appear differently based on the type of the object of focus. An object is associated with a defined set of properties that may correspond to properties of other objects, as well. An item is selected from a control object, such as a table, and causes a controlled object, i.e., a second table, to be populated with appropriate data. Data Listeners are used to determine when data change events occur. When an event occurs, a unique identifier is used to determine what queries are necessary to populate the subordinate table data. Controller and controlled tables may be nested in a variety of ways using a table controller connection class to identify how the unique identifier is correlated with the subordinate tables.

### CROSS REFERENCE TO RELATED APPLICATIONS

This application is related to U.S. patent application Ser. No. 09/---,--- (Docket No.: HP 10016746) to Inna Lauris, entitled “MECHANISM ALLOWING SEPARATION OF GRAPHICAL DISPLAY OF OBJECT STATUS FROM UNDERLYING DATA”, and U.S. patent application Ser. No. 09/---,--- (Docket No. HP 10016745) to Jonathan Patrizio and Eric Soderberg, entitled “SYSTEM AND METHOD FOR DISPLAYING A LAYOUT OF GUI PROPERTIES PANEL”, both applications filed concurrently and assigned to a common assignee, and herein incorporated by reference in their entirety.

### TECHNICAL FIELD

The technical field relates to a graphical display of data, and more particularly to a mechanism for selecting rows displayed in a layout of a graphical user interface properties in a panel where the action of selecting a row results in the display of related data.

### BACKGROUND

The Data Management Task Force (DTMF) developed the Common Information Model (CIM) in 1996 to provide a common way to share management information enterprise wide. The CIM schema provides models for various implementations to describe management data in a standard format. A number of graphic user interface (GUI) applications have been developed and deployed which take advantage of the CIM architecture.

According to a presentation by Winston Bumpus of the DTMF presented at the DTMF Comdex Management Presentation, Apr. 3, 2001, entitled, “Network Management and Administration”, best of breed applications are used to manage network and system infrastructure. Different applications gather different pieces of data about the same resource. It is difficult to aggregate data from disparate management applications for: service level measurement; true “end-to-end” view of a network; fault diagnosis; capacity planning; and resource usage billing. It is currently a very manual process (human intensive), inaccurate, slow and cumbersome. Thus a number of products have been developed, and are currently evolving to solve these problems.

The multi-computer/serviceguard (hereinafter “MC/ServiceGuard”) product, a product that is managed through ServiceGuard Manager and available from Hewlett-Packard Company, is a specialized facility for protecting mission-critical applications from a wide variety of hardware and software failures. With this system, multiple (up to 16-nodes) systems are organized into an enterprise cluster that delivers highly available application services to local area network (LAN) attached clients. ServiceGuard Manager is the management graphical user interface that can be used to monitor the health of each node and quickly respond to failures in a way that minimizes or eliminates application downtime. Status and information gathered about the network is presented to the user (network administrator) via a GUI.

The look and feel of a graphical user interface (GUI) is very subjective. User feedback is therefore essential for a GUI to be successful. It is advantageous to have a method for changing display appearance based on client/user feedback. Data indicating status and properties of objects monitored by the GUI process are strongly interrelated and can be presented in a variety of different ways. Further, addition/deletion of object types or relationship among the objects results in necessary modifications of the GUI layout in order to present the data to the user in a logical manner.

Graphical status displays used in the prior art GUIs to display status or properties of objects are encapsulated in source code. Thus, to change the GUI layout, or add/delete tabs or tables in a window, the developer is required to modify the source code and recompile the application code. This makes modification of the GUI layout slow and cumbersome because of the recoding and recompilation necessary. Moreover, each time source code is modified and recompiled, the risk of introducing new bugs (errors) into the GUI is increased.

### SUMMARY

A first aspect of the present invention is to reduce turnaround time to implement desired changes in a graphical display.

A second aspect is to provide a method for customizing the display characteristics of a graphic user interface (GUI) for various users using tabbed dialog panes.

It is yet another aspect of this invention to provide a generic mechanism to allow the easy modification of a visual layout of a GUI.

It is yet another aspect of this invention to provide a generic mechanism to define the layout of interrelated object properties, where the layout of similar panels appear differently based on the type of the object of focus. An object is associated with a defined set of properties that may correspond to properties of other objects, as well. The layout of this information appears differently depending on the object of focus.

A further aspect of the invention is the ability to select table rows and automatically populate rows of subordinate related tables.

These and other objects are achieved in a system that isolates all of the information that determines the look and feel of status and property layout displays of a GUI into one file. This file can be quickly edited to change the appearance when needed. The application source code utilizes a class schema and the modifiable file is read in and processed when the application is launched. Further changes require the application to be restarted to read in the modified file, though it would be possible to allow a new property sheet layout to be dynamically loaded while the application was running, if this was necessary.

According to one embodiment of the invention, a class schema is identified which defines the layout components of the GUI that should be modifiable. The class schema and the corresponding class instances are defined in managed object format (MOF) files. MOF files follow a standard format that is well known to those skilled in the art. It will be apparent to one skilled in the art that as the CIM technology evolves, other formats might be used.

Data Listeners are used to determine when data change events occur. When an event occurs, a unique identifier is used to determine what queries are necessary to populate the subordinate table data. Controller and controlled tables may be nested in a variety of ways using a table controller connection class to identify how the unique identifier is correlated with the subordinate tables.

### DESCRIPTION OF THE DRAWINGS

The invention will be described in detail in the following description of preferred embodiments with reference to the following Figs. wherein:

FIG. 1 is a screen shot of an exemplary top level screen of a ServiceGuard Manager product;

FIG. 2 is a screen shot of a General tab of a cluster property sheet;

FIG. 3 is a screen shot of a Packages tab of a cluster property sheet;

FIG. 4 is a screen shot of a Packages tab of a cluster property sheet with a selected package of focus;

FIG. 5 is a screen shot of a Nodes tab of a cluster property sheet;

FIG. 6 is a screen shot of a Nodes tab of a cluster property sheet with a selected node of focus;

FIG. 7 is a screen shot of a Network tab of a cluster property sheet;

FIG. 8 is a screen shot of a Network tab of a cluster property sheet showing a modified column layout;

FIGS. 9A and 9B show a class schema defining a layout for property sheets;

FIG. 10 shows a flow diagram illustrating an initialization phase for tables allowing row selection; and

FIG. 11 shows a flow chart illustrating a method of row selection.

### DETAILED DESCRIPTION

The numerous innovative teachings of the present application will be described with particular reference to the presently preferred exemplary embodiments. However, it should be understood that this class of embodiments provides only a few examples of the many advantageous uses of the innovative teachings herein. In general, statements made in the specification of the present application do not necessarily delimit any of the various claimed inventions. Moreover, some statements may apply to some inventive features but not to others.

In the present invention, a system is defined that isolates all of the information that determines the look and feel of property displays of a GUI into one file. In an illustrative embodiment the present invention is integrated with a MC/ServiceGuard clustering solution product, available from Hewlett-Packard Company. MC/ServiceGuard uses a GUI which consists of a tree and a map panel. Each object shown in the map or tree can be the focus object. Further, information corresponding to a focus object can be displayed in property sheet panels, as will be described in more detail hereinbelow.

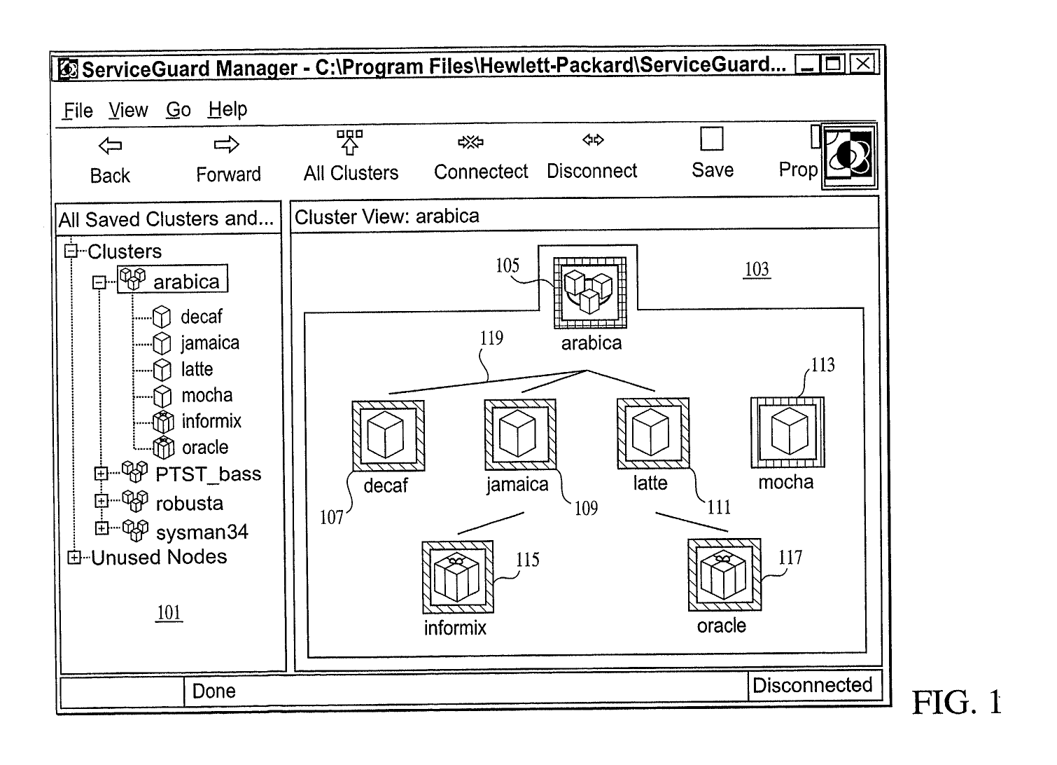

Referring now to the drawings, and in particular to FIG. 1, there is shown an exemplary top level screen shot of the ServiceGuard Manager product. The left panel 101 shows a tree of clusters, nodes and packages monitored by the MC/ServiceGuard clustering product. The right panel 103 shows a hierarchical map of these objects (clusters, nodes and packages) and how they are interrelated, with a specific focus on the cluster named arabica 105, as highlighted in left panel 101. The right panel or map view 103 shows user-selectable levels of the clusters, nodes and packages in the monitored system. In this exemplary view, arabica 105 has four (4) nodes: decaf 107, jamaica 109, latte 111, and mocha 113. There are also two (2) packages associated with the arabica cluster: informix 115 and oracle 117. The nodes decaf 107, jamaica 109, and latte 111 are connected to the arabica cluster 105, as shown by the lines 119. The node mocha 113, however, is not connected to the cluster.

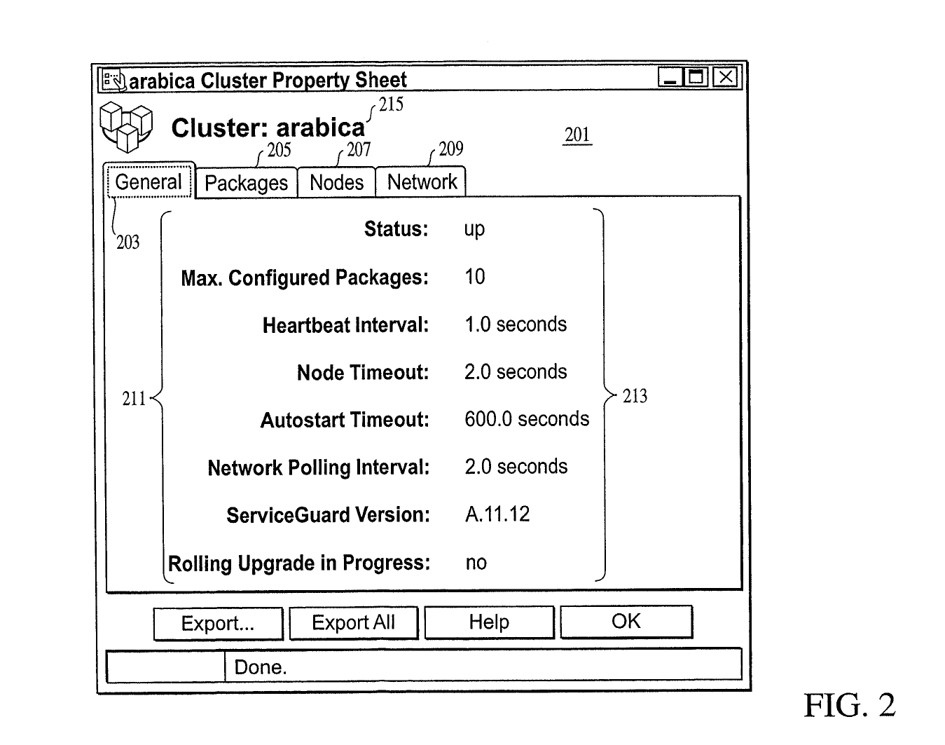

There are a number of properties associated with the exemplary object illustrated in FIG. 1. Referring now to FIG. 2, there is shown a property sheet 201 associated with the arabica cluster 105. As is understood in the art, a property sheet is a tabbed dialog pane, each of which illustrates various properties of that cluster. In this exemplary layout, there are four tabs associated with the arabica cluster property sheet: General 203, Packages 205, Nodes 207, and Network 209. The General tab 203 is shown on top, in this case, illustrating a particular set of information for the arabica cluster 105 described in more detail below.

With reference again to FIG. 2, there are two types of tabs within a given property sheet. First, there is just the general list-type structure with key value pairs. This is a simple tabbed dialog pane, as illustrated in FIG. 2. The left hand side of the given property sheet, designated in FIG. 2 by the reference numeral 211 is a component that might be a cluster status or a cluster name or a package name. The corresponding right hand side 213 would contain respective values thereof. The actual instance data name of a particular cluster name 215 is shown, in this case, arabica.

There is a more complicated pane which is a tabular type of pane. Sometimes tabular panes have a single table therein. Often times, however, there are multiple tables which are in some way related. A particular property sheet tabbed pane might require a multi-valued instance of data. For the arabica cluster 105, for example, the pane would have a Packages tab 205.

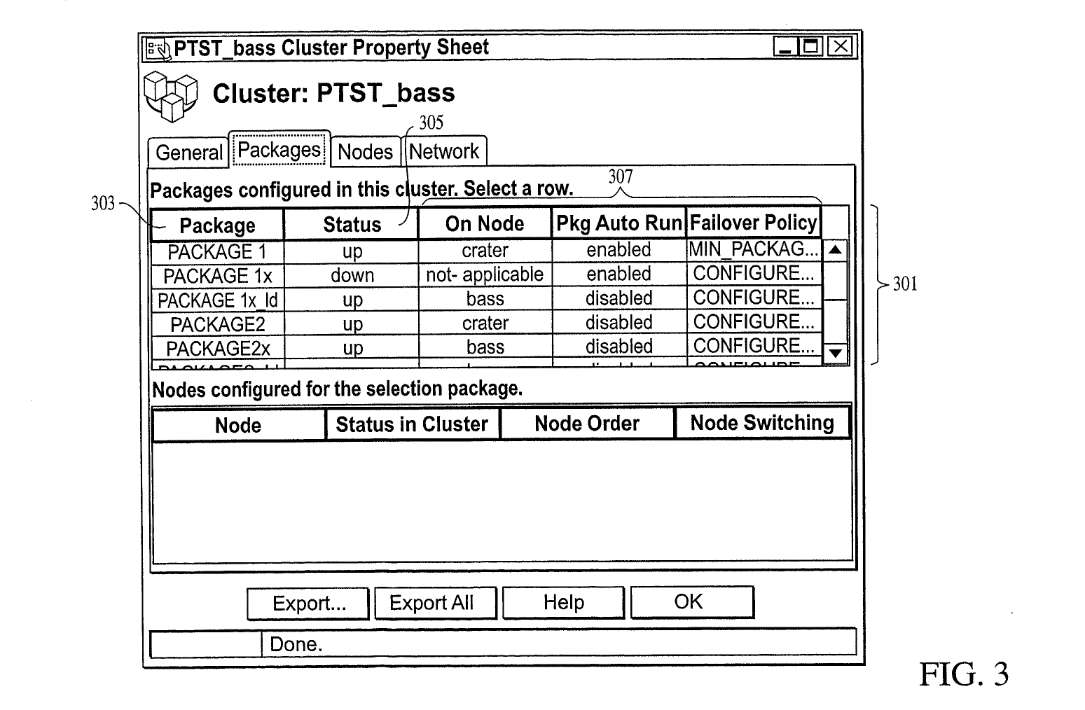

Referring now to FIG. 3, there is shown the Packages tabbed pane for the cluster property sheet. All of the packages that are configured for and currently running on that particular cluster are shown within a package table generally designated by the reference numeral 301. The respective packages are, represented as a table because there are multiple instances of the same attributes. In this exemplary layout, the attributes displayed are: the package name 303, the package status 305, and all the attributes of a particular package, generally indicated by the reference numeral 307, of interest to a person given information about that particular package.

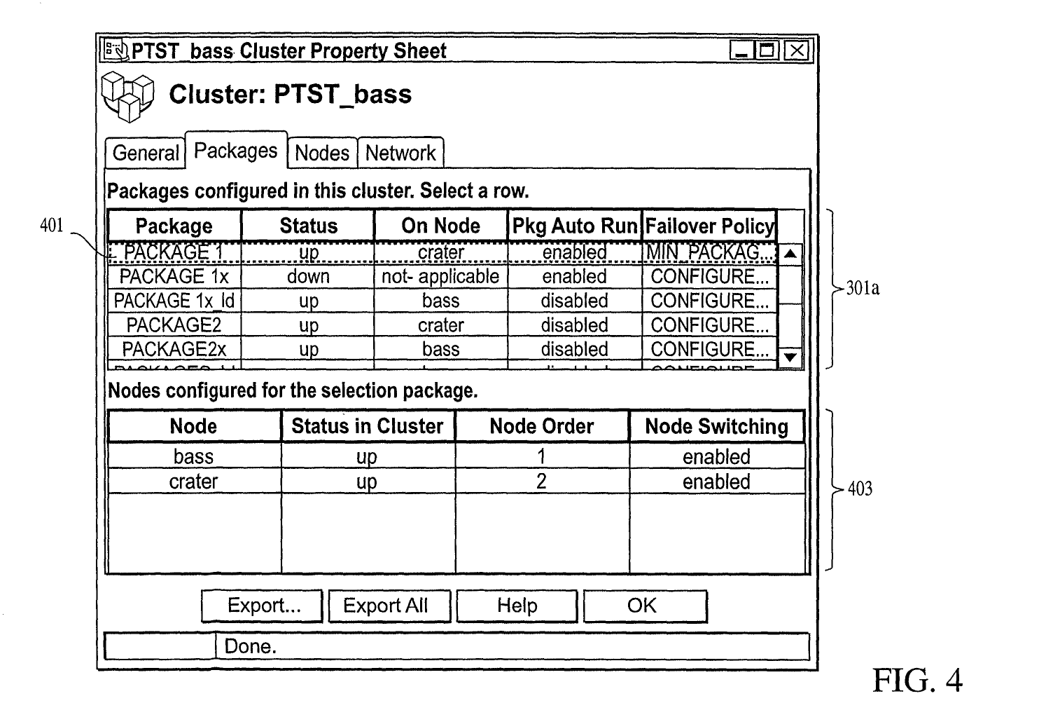

Referring now to FIG. 4, there is shown the Packages tabbed property sheet pane with a Package row selected, i.e., package 401. If more specific information related to a package shown in the package table 301a is desired, the user selects or highlights a row in that table. A preferred method for selecting is pointing and then clicking to the desired package using a pointing device, such as a mouse. Other methods, for instance, keyboard navigation, may be used. Once a row has been selected, a node table 403 is populated with appropriate data. The layout of the top package table and its relationship to the bottom node table are defined in a managed object file (MOF) file described in more detail. In this exemplary layout, a selection of a package row shows the nodes configured for the selected package, as well as related status data.

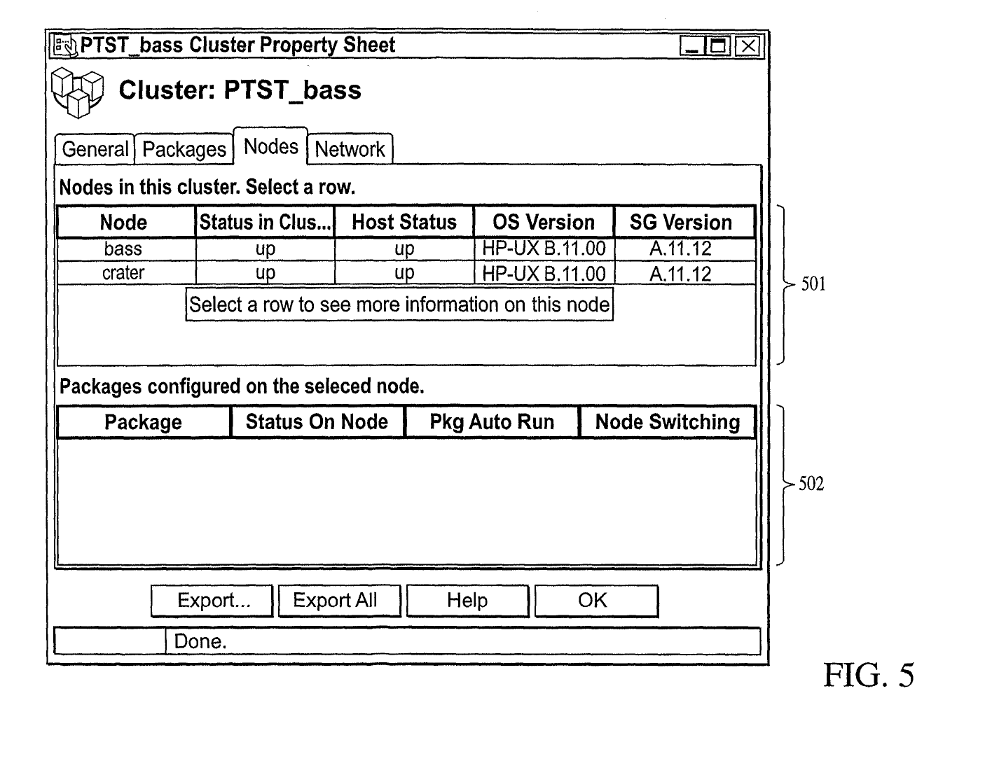

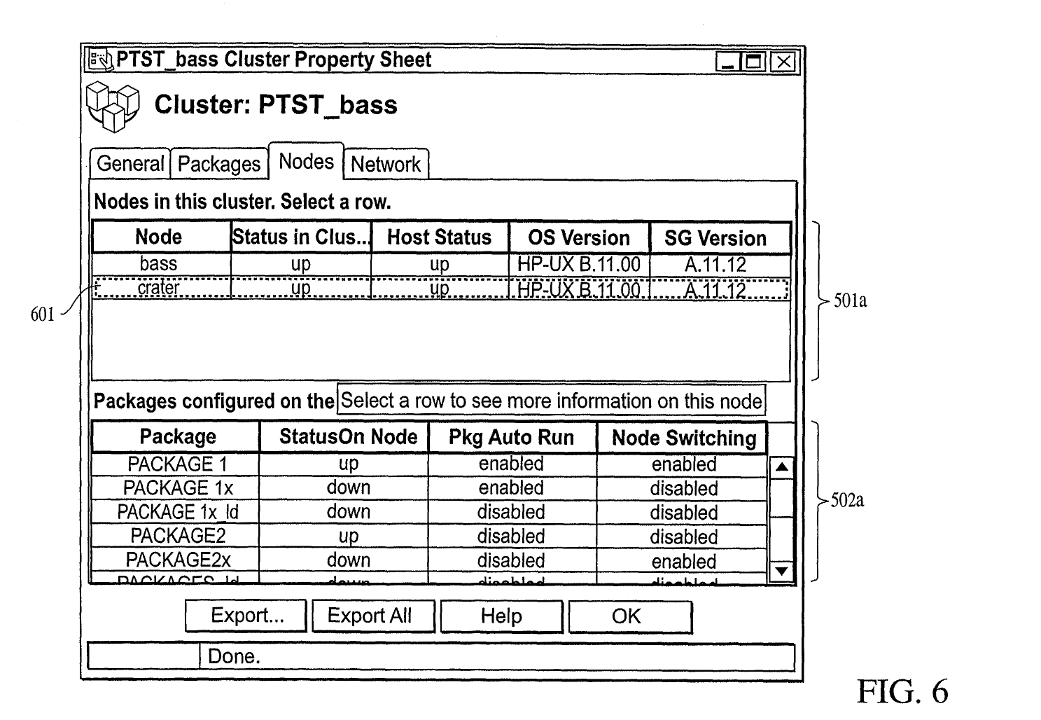

Referring to FIG. 5, there is shown the Nodes tabbed property sheet pane with no rows selected. A top node table 501 shows the nodes contained within the cluster of focus. The user can select a specific node (click on its row) to populate a lower packages table 502, as shown in FIG. 6. Referring now to FIG. 6, the lower packages table 502a shows the packages configured on the selected node row, i.e., crater in the upper node table 501a. It can be seen that the data presented for the node property sheet tab and the package property sheet tab contain similar data, but presented with a different focus.

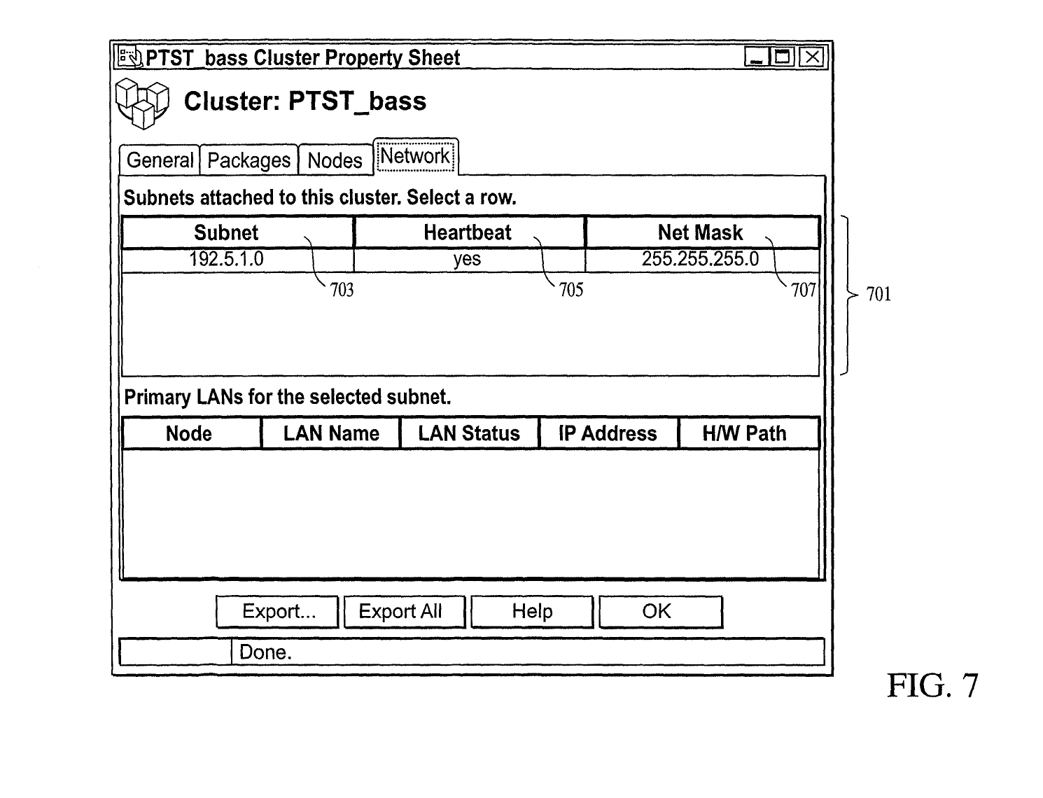

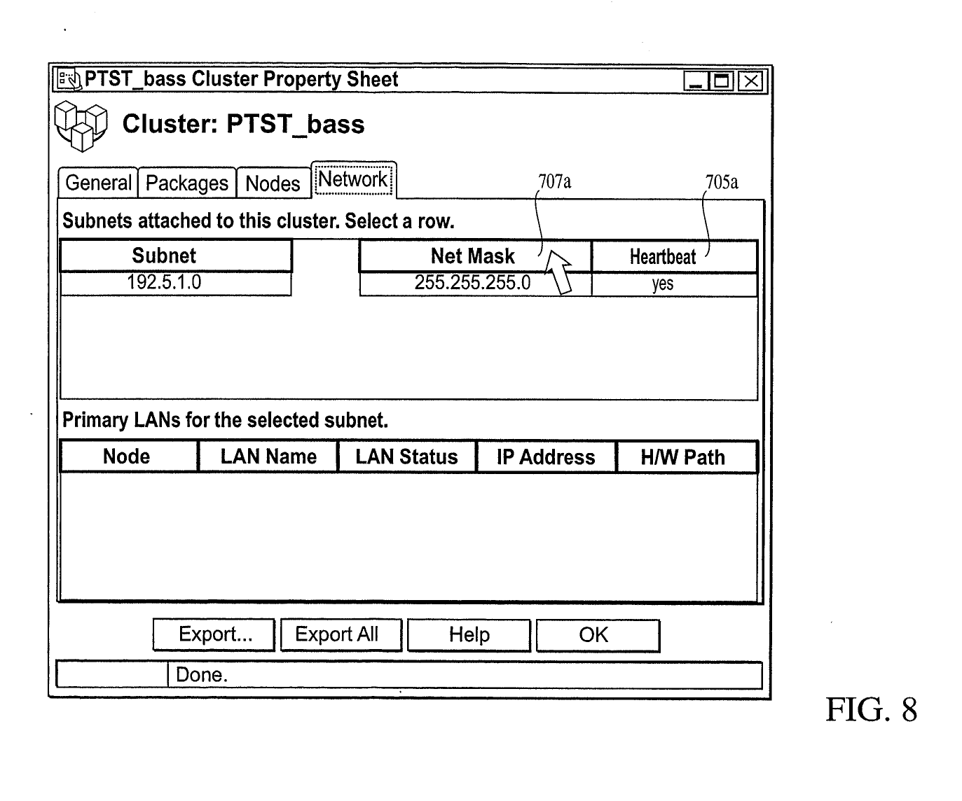

It is also possible for the user to modify some aspects of the GUI layout while the application is running. Referring now to FIG. 7, there is shown the Networks tabbed property sheet. A top subnets table 701 presents subnets on the cluster. There are three items of information presented for each row: subnet 703, heartbeat 705, and net mask 707. It is possible for the user to view this data in a different column order, if desired. For example, referring now to FIG. 8, the user switches the order of the second and third columns, i.e., heartbeat 705 and net mask 707, merely by dragging the column header to a different location. In this case, column net mask 707a is dragged from the third column in that row to the second. FIG. 8 shows the column net mask 707a in the process of being dragged. Column heartbeat 705a automatically moves to take the third column position, even before the user has dropped the Column net mask 707a to its final location.

As the monitored system becomes more complex, the user/network administrator may prefer to view properties and attributes of the various system objects differently. For instance, another object might be defined which would require the cluster property sheet to have five tabs rather than the four in the above illustrated embodiment. Therefore, the present invention defines a method and system which allows separation of the layout of the graphical display of object information from the underlying data. Instead of a rigid sequential ordering, the data is stored in managed object format (MOF) files which define the layout for display.

The application source code utilizes a class schema and the modifiable file is read in and processed when the application is launched. Further changes require the application to be restarted to read in the modified file.

According to one embodiment of the invention, a class schema is identified which defines the visual components of the GUI that should be modifiable. The class schema and the corresponding class instances are defined in managed object format (MOF) files. MOF files follow a standard format that is well known to those skilled in the art. It will be apparent to one skilled in the art that as the Common Information Model (CIM) technology evolves, other formats might be used.

An advantage of the present invention is derived from the ability to generalize the set of architecture and design of the property sheets so more complex combinations of tables and left-right value pairs could be rendered by the application. The property sheet is described in a general way in the MOF file. A managed object format file is really an ASCII representation of classes and then their instances. In the present invention, the MOF file contains control data that could then describe the ServiceGuard Manager program internally. It defines how to render and represent all the different attributes and features in which a customer might have interest.

Another feature of the present invention is gathering layouts and organizational information into a managed object format. In order to structure the MOF, a UML (unified modeling language) class diagram is developed. This class diagram is an illustration showing how the MOF file works and what would be contained inside this MOF file. For example, for the cluster property sheet described above, there is a MOF file which contains all of the necessary information representing that General tab, the cluster Packages tab, the Nodes tab, and the Network tab. Inside of a file that is internal to ServiceGuard Manager there is a MOF file which contains a description telling the program how a cluster property sheet should be rendered.

If a change to the layout of a cluster property sheet is required, the modifications are added to the MOF file. For instance, for an additional tab, further descriptions describing another tab are added to the MOF file and the code in the program would not need to be modified. Thus, the instances of the classes are modified in the MOF file, but the schema maintains generality and need not be modified. In one embodiment, the application is programmed using JAVA™ (JAVA is a trademark of Sun Microsystems, Inc.). The JAVA™ code that exists would read that definition file and would automatically render a new tab. Traditionally, the way this is done is to hard-code it in source code. Thus, JAVA™ code to specifically render all of the components needed for the cluster property sheet would need to be written and reintegrated into the existing code. In the preferred embodiment, the desired changes are entered into a pre-processor which checks the syntax and then generates the modified MOF file.

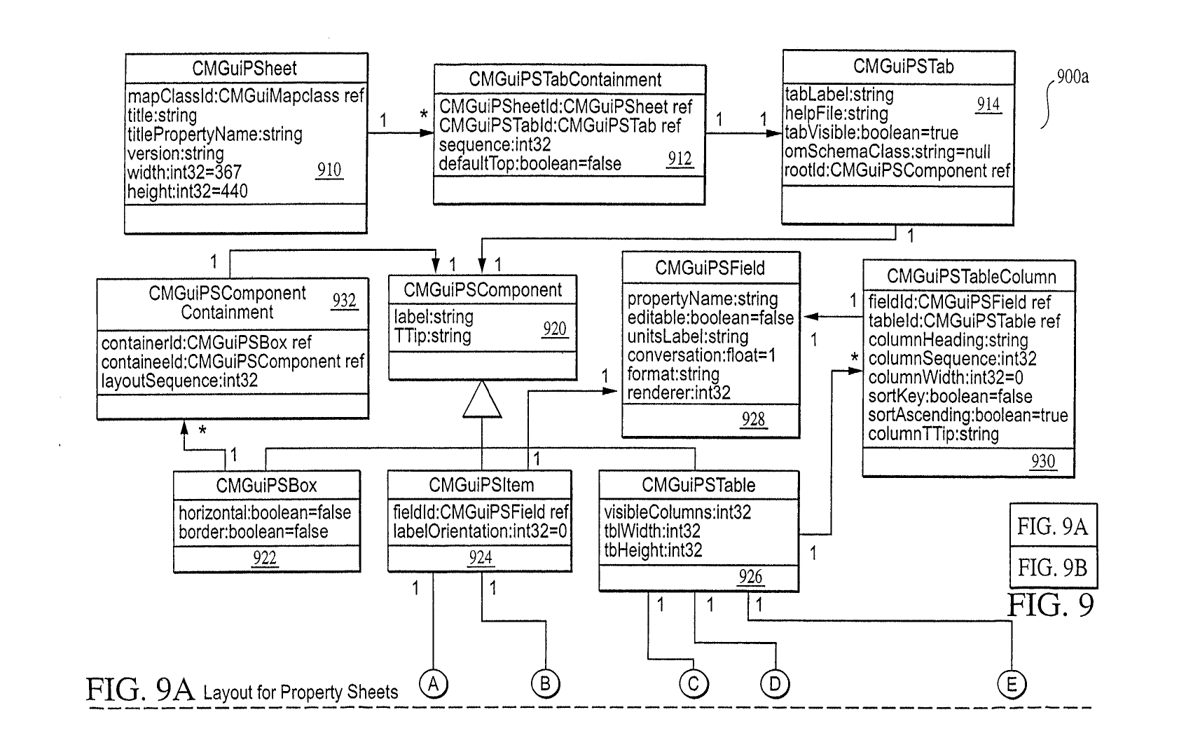

Referring now to FIG. 9A, there is shown a class schema, generally designated by the reference numeral 900a, for the property sheets, pursuant to the principles and teachings of the present invention. Class CMGuiPSheet 910 defines the general property sheet, and has a class identifier (mapClassId), a title string, a title property name string, a version and a default height and width, as illustrated in the Figure. In the exemplary embodiment, there are three objects having property sheets: cluster, node and package. Therefore, there will be three instances of the CMGuiPSheet class in the MOF file that holds the instances of the defined classes. If a new object is defined, the schema 900a requires no modification. The instance MOF file would be modified to add the new property sheet instance and associated class instantiations.

The CMGuiPSheet class has a one-to-many relationship with a CMGuiPSTabContainment class 912, which defines a tab for containment within the property sheet. A sheet may have multiple tabs. The sequence of tabs is also defined here. The sequence defines the order in which the tabs appear (top to bottom). The actual sequence is identified in the instance MOF file. Because there is a one-to-many relationship, a property sheet defined to have four tabs will have four instances of the containment class. For instance, in an exemplary embodiment, there are several tab containment instances for a cluster property sheet. The MOF file would therefore include the following instantiations:

instance of CMGuiPSheet {

id = “CMGuiPSheet:SGCluster”;
mapClassId = “SGCluster”;
title = “PSMOF_SGCluster_title”;
titlePropertyName = “name”;
version = “010502”;
width = 480;
height = 420;

};
instance of CMGuiPSTabContainment {

id =

“CMGuiPSTabContainment:CMGuiPSheet:SGCluster+CMGuiPSTab:CMGuiPSh
eet:SGCluster:1”;

CMGuiPSheetId = “CMGuiPSheet:SGCluster”;
CMGuiPSTabId = “CMGuiPSTab:CMGuiPSheet:SGCluster:1”;
sequence = 1;
defaultTop = true;

};
instance of CMGuiPSTabContainment {

id =

“CMGuiPSTabContainment:CMGuiPSheet:SGCluster+CMGuiPSTab:CMGuiPSh
eet:SGCluster:2”;

CMGuiPSheetId = “CMGuiPSheet:SGCluster”;
CMGuiPSTabId = “CMGuiPSTab:CMGuiPSheet:SGCluster:2”
sequence = 2;
defaultTop = false;

};
instance of CMGuiPSTabContainment {

id =

“CMGuiPSTabContainment:CMGuiPSheet:SGCluster+CMGuiPSTab:CMGuiPSh
eet:SGCluster:3”;

CMGuiPSheetId = “CMGuiPSheet:SGCluster”;
CMGuiPSTabId = “CMGuiPSTab:CMGuiPSheet:SGCluster:3”
sequence = 3;
defaultTop = false;

};
instance of CMGuiPSTabContainment {

id =

“CMGuiPSTabContainment:CMGuiPSheet:SGCluster+CMGuiPSTab:CMGuiPSh
eet:SGCluster:4”;

CMGuiPSheetId = “CMGuiPSheet:SGCluster”;
CMGuiPSTabId = “CMGuiPSTab:CMGuiPSheet:SGCluster:4”;
sequence = 4;
defaultTop = false;

};

Other instances of a CMGuiPSTableContainment may be created in the MOF file. If the tabVisible Boolean which is part of the related class CMGuiPSTab is FALSE, then this tab would not be visible to the user. In this way, the GUI can be made more generic, allowing tabs to be easily made visible or invisible depending on the needs or authorization level of a user. This provides a way to conditionally turn-on tabs for different customers, if desired. Therefore, the instances that are seen in the MOF file that don't appear when ServiceGuard Manager is run, have simply been disabled.

The property sheet for a node also has several tab containment instances. The MOF file would therefore include the following instantiations:

instance of CMGuiPSheet {

id = “CMGuiPSheet:SGNodePackage”;
mapClassId = “SGNodePackage”;
title = “PSMOF_SGNodePackage_title”;
titlePropertyName = “name”;
version = “010502”;
width = 520;
height = 440;

};
instance of CMGuiPSTabContainment {

id =

“CMGuiPSTabContainment:CMGuiPSheet:SGNodePackage+CMGuiPSTab:CM
GuiPSheet:SGNodePackage:1”;

CMGuiPSheetId = “CMGuiPSheet:SGNodePackage”;
CMGuiPSTabId = “CMGuiPSTab:CMGuiPSheet:SGNodePackage:1”;
sequence = 1;
defaultTop = true;

};
instance of CMGuiPSTabContainment {

id =

“CMGuiPSTabContainment:CMGuiPSheet:SGNodePackage+CMGuiPSTab:CM
GuiPSheet:SGNodePackage:2”;

CMGuiPSheetId = “CMGuiPSheet:SGNodePackage”;
CMGuiPSTabId = “CMGuiPSTab:CMGuiPSheet:SGNodePackage:2”;
sequence = 2;
defaultTop = false;

};
instance of CMGuiPSTabContainment {

id =

“CMGuiPSTabContainment:CMGuiPSheet:SGNodePackage+CMGuiPSTab:CM
GuiPSheet:SGNodePackage:3”;

CMGuiPSheetId = “CMGuiPSheet:SGNodePackage”;
CMGuiPSTabId = “CMGuiPSTab:CMGuiPSheet:SGNodePackage:3”;
sequence = 3;
defaultTop = false;

};
instance of CMGuiPSTabContainment {

id =

“CMGuiPSTabContainment:CMGuiPSheet:SGNodePackage+CMGuiPSTab:CM
GuiPSheet:SGNodePackage:4”;

CMGuiPSheetId = “CMGuiPSheet:SGNodePackage”;
CMGuiPSTabId = “CMGuiPSTab:CMGuiPSheet:SGNodePackage:4”;
sequence = 4;
defaultTop = false;

With reference again to FIG. 9a, the CMGuiPSTabContainment class 912 has a one-to-one relationship with a CMGuiPSTab class 914. This class specifies that each tab has a label, associated help, and visibility flag. The main purpose of this class is to connect property sheets and tabs. An advantage of this method is that a particular style of tabs could be shared among different property sheets. Moreover, because the help string is associated with a tab, context sensitive help is available at the tab level rather than at just the property sheet level. The visibility flag allows a tab to be made invisible, if desired. This allows a set of users to be blind to some data for security, aesthetic or other reasons, or more accurately, for a vendor or developer to control which of the tabs are seen by various customers. A tabVisible flag can easily be inverted from false to true to enable a particular customer to see the tab, without having to change their source code.

A CMGuiPSComponent class 920 is an abstract class type. In other words, CMGuiComponents are not actually displayed on the layout. What actually is displayed in the layout are items, boxes or tables. A box is a mechanism for grouping a number of components together. Thus, there is a circular route in the schema from the CMGuiPSComponent class 920 and CMGuiPSBox 922, CMGuiPSItem 924, and CMGuiPSTable 926 classes. As shown by the schema diagram, boxes, items and tables are components. An item may have a field (one-to-one relationship) associated with it, as shown by CMGuiPSField class 928. A table has associated columns (one-to-many relationship) as shown by CMGuiPSTableColumn class 930. Boxes may contain other components, including other boxes, tables, or items, as shown by the one-to-many relationship between CMGuiPSBox class 922 and CMGuiPSComponentContainment class 932.

Because of this architecture, a layout may have an arbitrary number of boxes, contained within boxes, which contain combinations of items and tables. This a very general structure that allows a layout to have a box, which contains an item followed by another box, which could contain another table, which could then contain another table. Then the layout could have another box within that which could have three more items in it. It is a very general way of kind of organizing all of these different kinds of components. Furthermore, the box can specify the Boolean property horizontal which controls whether components within it are laid out side-by-side or top-to-bottom.

In the preferred embodiment, the data on the property sheets is populated using a method defined by the data class schema 900 (900a and 900B), as shown in FIGS. 9A and 9B. Referring now to FIG. 9B, a connection between items and tables classes is shown to CMGuiTableConnection class 950. This is a one-to-one relationship and allows each item or table to identify where (from which table) it retrieves its data. The rendered value that an item or table displays is governed by the CMGuiPSField.propertyName 998 field, which must select a column resulting from the evaluation of a SQL queryString encapsulated in CMGuiTable 970. To state this in an alternative way, all instance data is retrieved by running SQL queries and CMGuiTableConnection 950 provides the JAVA™ code with a way to correctly select displayed data from a superset of data, resulting from running a particular SQL query.

The tables class is also connected to CMGuiTableControllerConnection class 960. This class controls the display of table data related to a selected row in the focus table, as described above. The CMGuiTableControllerConnection class 960 and the CMGuiTableConnection class 950 are also connected to CMGuiTable 970, which controls the querying of data, as described in the previous paragraph. The CMDataListener interface 990 allows a component to receive CMDataEvents 980, arriving when changes to this data arise. This provides a mechanism for changing displayed data when underlying changes occur in the ServiceGuard Manager system. In this exemplary embodiment, the CMGuiTable 970 has a one-to-one relationship with CMDataEvent 980 and CMDataListener interface 990. In the preferred embodiment, these classes 980 and 990 are JAVA™ classes. It will be apparent to one skilled in the art that a variety of methods can be used to populate the layout with data.

The classes contain numerous properties, used by the JAVA™ code to control the layout. For example, to change the width and height of a particular property sheet, the width and height parameters are changed in the MOF file via the CMGuiPSheet 910 instance for this property sheet. Its title (displayed at the head of the property sheet) is changed via the title field. It will be apparent to one skilled in the art that other modifications to the GUI layout can be effected using the method of the present invention, as desired. For instance, color, perspective, button type, etc. could be defined in the layout classes. A method for defining visual indicators in MOF files is described in concurrently filed U.S. patent application (Docket No.: HP 10016746) entitled, “Mechanism Allowing Separation Of Graphical Display Of Object Status From Underlying Data”, supra.

The field CMGuiPSTabContainment.layoutSequence controls the ordering of tabs within a property sheet. The CMGuiPSComponentContainment.layoutSequence allows the components (boxes, items or tables) within the box to be re-ordered. As mentioned above, the CMGuiPSBox.horizontal flag can be used to control whether components within the box are laid out horizontally (side-by-side) or vertically (end-to-end). Table headings, tooltips and individual column names can be set via the MOF file by altering the fields of instances.

Referring again to FIG. 4, the ability to select a row on the property sheet and automatically display related data in formation is an advantage over the prior art. A problem of the prior art is the inability of GUI displays to provide sufficient information to the users. In the exemplary embodiment, there is shown a top table 301a and a related bottom table 403. It will be apparent to one skilled in the art that additional related tables may be implemented. The user can select any row of the top table 301a to discover more detailed information about the row instance selected. Controlled tables represent multi-valued (many rows) of additional information needed to complete the picture for a given row selection. In the packages tab shown in table 301a, the top table shows packages configured on the cluster PTST_bass. The first package PACKAGE1 401 is selected and the controlled (lower) table 403 shows the nodes on which the package is configured to run. It is difficult to show this information in a single table, since multi-valued entries in a single table cell would not be scalable for large numbers of entries. The present invention allows drill-down capability for the user.

Any row selected from a control table, in this example, top table 301a, can trigger a new view of the data in one or more lower tables. It will be apparent to one skilled in the art that the location of the control table may be displayed in other arrangements as compared to the dependent tables. For instance, the control table might be to the left of a dependent table, or below it. In the exemplary embodiment, the related data to be displayed in a dependent table is discovered and rendered using a Model-View-Controller (MVC) model and retrieved via SQL queries. Control data for the algorithm is stored in a MOF schema and read in by the application at launch (start-up) time.

The Model-View-Controller model is well known by those of ordinary skill in the art. The Model is an object or collection that represents application data. A model is a simplification of reality, created in order to better understand the system being created; in other words, a semantically closed abstraction of a system. The View is what the user sees. It is a projection into a model, which is seen from a given perspective or vantage point and omits entities that are not relevant to this perspective. The Controller responds to user requests. MVC is a paradigm for building programs that interact well with the user. Basic concepts of this object-oriented paradigm are described in an article by Steve Burbeck, entitled “Applications Programming in Smalltalk-80™: How to use Model-View-Controller (MVC)”, (copyright 1987, 1992 and published on the Internet at http://st-www.cs.uiuc.edu/users/smarch/st-docs/mvc.html). A brief overview of the MVC paradigm as described in the Burbeck, supra, article follows.

In the MVC paradigm the user input, the modeling of the external world, and the visual feedback to the user are explicitly separated and handled by three types of object, each specialized for its task. The view manages the graphical and/or textual output to the portion of the bitmapped display that is allocated to its application. The controller interprets the mouse and keyboard inputs from the user, commanding the model and/or the view to change as appropriate. Finally, the model manages the behavior and data of the application domain, responds to requests for information about its state (usually from the view), and responds to instructions to change state (usually from the controller). The formal separation of these three tasks is an important notion that is particularly suited to Smalltalk-80 where the basic behavior can be embodied in abstract objects: View, Controller, Model and Object. The MVC behavior is then inherited, added to, and modified as necessary to provide a flexible and powerful system.

In other words, the Model-View-Controller architecture is a fundamental premise in JAVA™ programming related to how different JAVA™ objects are used to interact and present data. An example which is similar to an implementation of the present invention uses Jtables. A Jtable is a JAVA™ object and CMGuiPSTable (FIG. 9A, reference 926 ) is in fact a class which extends the class Jtable plus a JAVA™ component. It is designed to utilize this model view control architecture. In order to get data into a particular table, a model is defined for the table. The model contains the information, or data, for the view. The rendering (e.g., physical attributes or graphical layout) of the table is separated out from the actual data itself. The model and rendering must have a connection.. This connection is the controller. When a view is created, in order to get data for a graphical user interface, the Jtable is created, and also a view model, implemented by the Swing JtableModel class. The controller controls how the model is updated. There is a kind of triangle of control which is that there is a view, and the view presents the data in a certain way. The data for that view is stored in a model and the model is controlled by a controller.

In a preferred embodiment, a Model-View-Controller architecture is used. This establishes data views at initialization time. After the initialization phase is complete, very little computation is necessary to fire new events, based on user row selection. Row selection can cause any other controlled table to fire, or be populated, simply by setting a SQL embedded query variable to a known unique value.

Referring again to FIGS. 9A and 9B, in a particular embodiment of the present invention, a CMGuiTable 926 is defined which is a JAVA™ Jtable. A CMGuiTable 970 is defined, which is the table model. There must be a controller, there must be a way of controlling how that data is fired up into the actual CMGuiPSTable 926. For this particular row selection algorithm, there is a way of selecting a particular row instance of one table. An identifier is used that is present in that particular row. That identifier is then used to set a query variable. The query variable is an attribute of CMGuiTable 970.

The query variable attribute of CMGuiTable 970 is a control point. In essence, the schema provides a table model which has an embedded SQL query string stored in that second attribute of CMGuiTable 970, called query string. The query string is used by the Java™ code to set up a model for the CMGuiPSTable. In one embodiment of the present invention, the GUI has a whole class of objects called a view, that is denoted by CMView.

The API (application programming interface) utilizes CMViews. CMViews contain “instance tables.” An instance table is the result of running a SQL query. When a SQL is run, the results are at one single point and time where the query was executed, or an instance in time. For example, a query might be to select all attributes of a specific cluster. The results are returned in the instance table. A kind of a wrapper surrounds the query which provides more about how the data is retrieved. If a query string is set up with a condition that cannot be immediately evaluated then a particular query variable must be set so that the CMView can be evaluated when needed by running the query. When the property sheets are initialized, all of these CMViews are created using their embedded query strings. If the query strings can be immediately evaluated, then data can be rendered on the property sheet. Generally, the top level tables have their query variable automatically set. For example, referring again to FIG. 1, the user selects the arabica cluster 105 by right clicking on the icon., and then selecting to view the property sheet for the arabica cluster. The property sheet as illustrated in FIG. 2 is displayed without needing additional user input because the query associated with this view is dependant only on the cluster ID. In other words, the property sheet is rendered in a certain context, i.e. on a given cluster ID. The query already knows how to evaluate any of the top table queries because the queries are run on a particular ID that is known in the context of the current view or selection.

The lower, or controlled, tables use a secondary computation. It is set up so that initially when the property sheet view is rendered, the cluster ID is known. Thus the top level queries can be evaluated. If there is a second table, or a multiple second controlled table, the queries won't evaluate those until the results of the first query have come back. In one embodiment, the controlled tables bring up data related to the first row in the top table. Another embodiment waits until the user selects a row before displaying the secondary, or controlled, data.

The Model-View-Controller architecture is the general architectural paradigm. CMGuiPSTable 926 is the View portion of the paradigm. The class CMGuiTable 970 is the model portion of the paradigm. CMDataEvent 980 is the Controller portion of the paradigm. When there is a basic change to underlying data, CMDataEvents are generated and received by the table implementing the CMDataListener interface. The query is set up so that if there is any resulting change to that particular instance table CMDataEvent 980 is fired. A particular interface called dataChange is then run as a method in the component implementing the CMDataListener interface 990. Thus, whenever an CMDataEvent 980 arrives, the controller, will automatically call a method called dataChange which is implemented by the model code called CMGuiTable 970. For example, when new data resulting from a query which was previously executed is received, the dataChange is activated. There are many event methods for JAVA™ objects; these event methods are not documented on the schema diagram. It will be apparent by one of skill in the art how these events are implemented, because firing of an event is actually a general JAVA™ Swing paradigm.

The architecture triggers changes in a particular model, so that these changes percolate up into a CMView. In essence, the data changes, and a controller method recognizes the data change and modifies the form to a renderable version. It then triggers a fire table data change event, which is basically a trigger to tell the actual Jtable to redraw itself. The Jtable redraws itself using an algorithm that runs down through all its rows and columns and it retrieves the new data.

In one embodiment of the present invention, the dataChange event might retrieve and redraw nothing more than a row of numbers, i.e., a matrix of numbers in the table. Thus, when the new data comes in, a CMDataEvent occurs and you get a new set of data. In another embodiment, the data must be modified before viewing or rendering it. For example, perhaps the view of the raw data requires multiplying every row item by two. This is performed by processing the new raw data in the dataChange event so that each entry is doubled before rendering the new view. Every single entry in the actual model is processed in this way. When this doubling process is complete, then a fire table data changed event is sent. This informs the Jtable that it is rendered physically in the GUI and causes the Jtable to update itself. Then the one single method immediately and automatically renders the new data.

The present invention uses an additional level of indirection over the Model-View-Controller paradigm to build on the general method of how tables render the data. Referring again to FIG. 4, a user viewing a property sheet can select a row 401 to identify a given control point in a top table 301a. This act of selection sets the unique row ID which in turn defines and sets the query variable for the bottom table 403. Referring again to FIG. 9B, CMGuiTableConnection 950, tells the table where its data is, i.e., where the model is. So in other words, CMGuiTableConnection 950 links the CMGuiPSTable 926 (FIG. 9A), which is a view, to its model CMGuiTable 970. This is basically a direct connection that identifies the source of the data to render a particular table and how to construct a CMView containing the correct SQL query string. The CMGuiTableControllerConnection 960 comes into effect for this row selection. The CMGuiTableControllerConnection 960 links a particular control table to a particular controlled table. In other words, it specifies that the control table controls the data model for another table. The models are directly tied to their views in the Model-View-Controller architecture. Therefore by utilizing the CMGuiTableControllerConnection 960, the model of another table, of another view in fact, can then be controlled. An attribute of the CMGuiTableControllerConnection 960 is a string named, idProperty. The idProperty attribute is the name of the column in the originating CMGuiTable 970 that is used to set the queryVariable string attribute in CMGuiTable 970. Thus, idProperty uniquely identifies the row on the table which the user has selected. Referring again to FIG. 4, in the exemplary embodiment, the unique id of a row in top table 301a is the Package name (first column in row 401 ). In alternative embodiments, this name may not be used as a unique identifier of this row. In that case, it is necessary to place a unique key (that perhaps is not visible to the user) that can be used for idProperty.

In the exemplary embodiment, the user selects the first row 401 of the top table 301a. It is determined whether table 301 a has any instance of CMGuiTableControllerConnection 960. If not, then it has no controlled tables and in some embodiments, row selection is impossible. A single table may in fact have one or more CMGuiTableControllerConnection 960 instances, or control one or more tables; one particular table could control a number of other models or other tables. If an instance of CMGuiTableControllerConnection is found, then that means that this table controls at least one other table. If there were two instances of CMGuiTableControllerConnection 960 then the row selection controls two other tables. Each of the CMGuiTableControllerConnection 960 instances have an idProperty and that identifies which unique attribute of the row that was selected should be used and extracted to then set the queryVariable used by CMGuiTable 970.

In another embodiment, table control is nested. It is possible for one view to have more than two tables. In one embodiment, a first table controls both a second and third table. The first table has two CMGuiTableControllerConnection instances with the same idProperty, but different CMGuiPSTableid's, one for each controlled table. Another embodiment has a first table that controls a second table and the second table controls a third table, rather than the first table controlling both the second and third tables. Thus, the dataChange events cause dataChange methods to execute in succession with a rippling effect. Once a unique idProperty is selected in the first table, the second table is rendered. The third table may be controlled by the newly rendered second table, or in another embodiment, a row is selected in the second table to identify another idProperty before rendering the third table. For instance, different columns of the same selected row can trigger a desired query. Thus, only one row in the first table need be selected in order to render two additional tables.

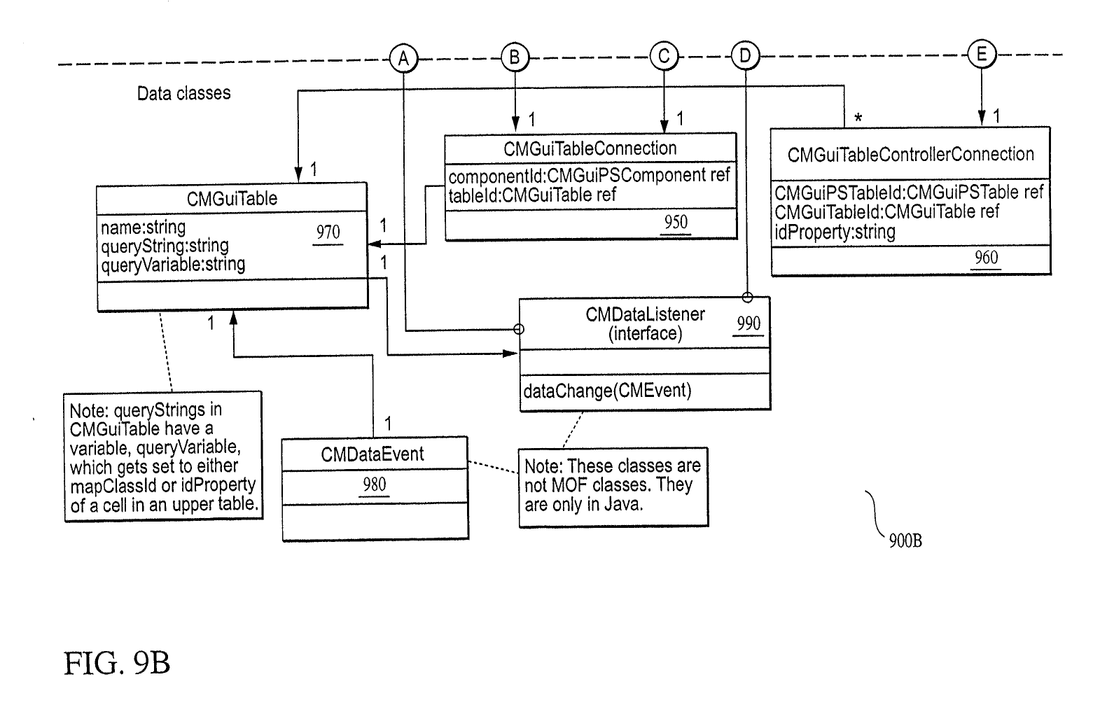

Referring now to FIG. 10, there is shown a flow diagram illustrating the initialization phase of an exemplary embodiment of the present invention. In this context, initialization is the point when a property sheet is invoked, and initially rendered, before any row is selected. This flow chart will be described as compared with the schema diagram in FIGS. 9A and 9B. The top table data view is created using SQL query in block 1010. On the schema diagram this relates to a CMGuiPSTable 926. The top table is rendered by creating a CMGuiTableConnection 950 to a CMGuiTable 970. The query referred to in block 1010 is the queryString attribute of CMGuiTable 970. At startup, a CMGuiTable is created for each instance of CMGuiTableConnection 950. In the JAVA™ code, a CMGuiTable contains a CMView which is constructed using the queryString. A data listener, CMDataListener interface 990 is then attached to the top table, CMGuiPSTable 926 in block 1020. This sets up the Model-View-Controller architecture. The data listener is necessary to match events with table views.

Attaching a data listener is a standard JAVA™ occurrence. In order for a JAVA™ component to respond to a particular data event, a list data listener is attached. It is basically a registration; i.e., registering a particular object with a thing called Listener Interface. Thus, when those data events occur, the interface gets activated and the dataChange method of the object is called. Attachment is an important JAVA™ concept which allows a particular object to respond to data events.

The SQL query executes if there are no unsatisfied variables in the query string and after evaluation, causes a CMDataEvent event to be generated in block 1030. This event is caught by the dataChange method and the evaluated instance table is passed on to the table model, where it is used to update the data and then trigger the visible update by generating a corresponding table data changed event. This is how the top table gets its data. The SQL query runs, data is rendered in top table, based on a data change event.

Lower tables are created using SQL query with embedded query variables, so if a layout, or view, has a lower table, then there is a controlled table. The lower, or controlled, table queryString has variables in it which cannot be satisfied until a row is selected. The lower table views, if any, are created using the embedded query variable in block 1040. It will be apparent to one skilled in the art that top tables are tables that can be immediately computed because the query variables are definite and defined when the query strings are first used to create the CMViews. They need not be physically above or on top. Lower tables are somewhat more indirect. A lower table has query variables embedded inside of the queries. The values of the query variables for lower tables are not immediately known. It will be apparent to one skilled in the art that a lower table need not be physically below or under the top tables.

In block 1050, data listeners, CMDataListener 990, are attached to each lower table. The data listeners for the lower tables do not fire until the SQL query can be finally evaluated with embedded query variable.

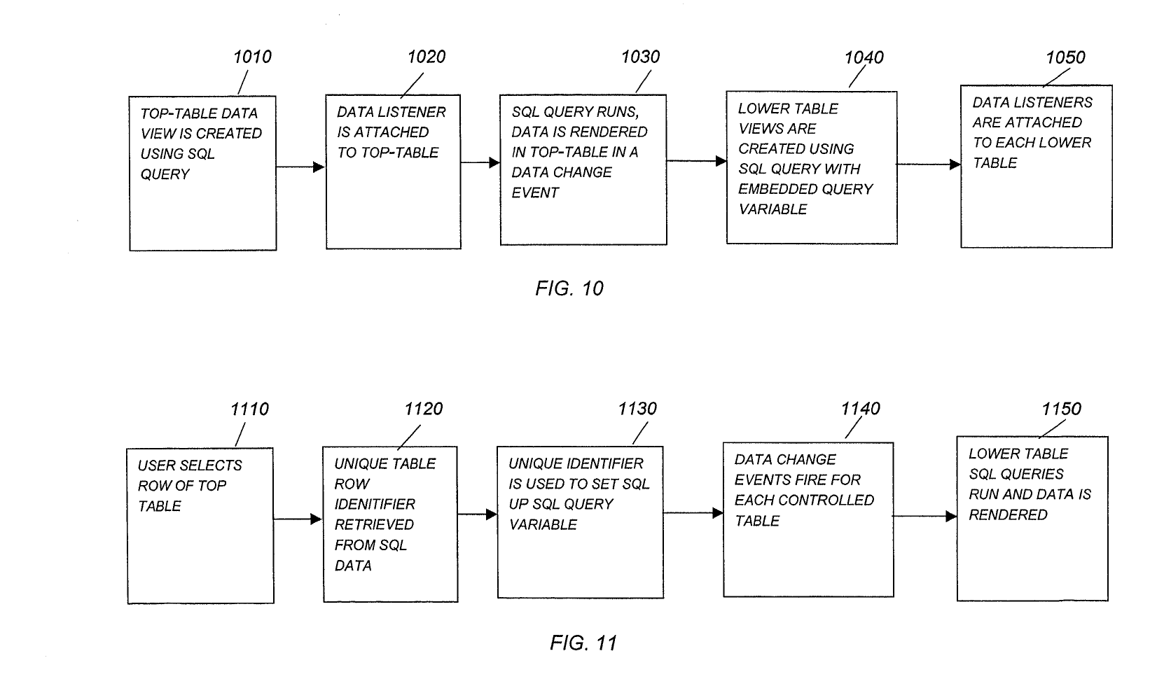

Referring now to FIG. 11, there is shown a flow chart illustrating a method of row selection. FIG. 11 describes the interaction of CMGuiTableControllerConnection 960. The user selects row of top table in block 1110. The unique table row identifier is retrieved from SQL data in block 1120. This identifier is what is described above as the idProperty string attribute of CMGuiTableControllerConnection 960. The user has selected a row; thus, it is known horizontally which row of the information is needed. The idProperty identifies a column in the selected table. With these two pieces of information, the unique row identifier is then extracted.

The unique row identifier extracted in block 1020 is used to set up an SQL queryVariable in block 1030. At this point and time, the queryVariable of the CMGuiTable 970 that is to be controlled is known. This results in that query being possible to run. Now that it is possible to evaluate the query variable, the query will automatically run. Setting the query variable in the background causes the query to be evaluated which then fires CMDataEvent in block 1140, which, in turn, activates CMDataListener interface,. It should be noted that data change events fire for each controlled table.

There may be a situation where one row selection causes multiple major events to fire. Because multiple query variables will be set, every CMGuiTableControllerConnection 960 will result in a subsequent call of set query variable of a particular idProperty name and row. For each one of those query variables to get set there will be a corresponding number of CMDataEvents 980 fired by the application. Data changes for each event will be run, and then for each data change there will be a fired data change event for each control table. The lower table SQL queries are actually run in block 1150, and the data is rendered.

Having described preferred embodiments of a novel method for selecting rows in a controlling table and displaying subordinate controlled tables with related data (which are intended to be illustrative and not limiting), it is noted that modifications and variations can be made by persons skilled in the art in light of the above teachings. It is therefore to be understood that changes may be made in the particular embodiments of the invention disclosed which are within the scope and spirit of the invention as defined by the appended claims.

Having thus described the invention with the details and particularity required by the patent laws, what is claimed and desired protected by Letters Patent is set forth in the appended claims.

In the claims:

1. A method for selecting rows displayed in a layout of a graphical user interface where the action of selecting a row results in display of related data, said method comprising:
creating a table view for a controlling table;
attaching a data listener to the controlling table;
rendering data in the controlling table;
selecting an item of the controlling table, the item defining a unique identifier of the controlling table;
setting a query variable for each of the at least one controlled table, wherein the query variable is related to the unique identifier;
firing a data change event, to be received by the data listener, for each of the at least one controlled table;
running queries using the query variable set for at least one controlled table; and
rendering data for at least one controlled table, wherein the rendered data in the at least one controlled table is related to data in the controlling table.

2. The method as recited in claim 1, wherein data used to populate the controlling table is retrieved from a database using standard database queries with the query variables set in the starting phase.

3. The method as recited in claim 1, wherein the step of selecting an item further comprises retrieving the unique identifier for the controlling table.

4. The method as recited in claim 1, wherein at least one given controlled table is also a controlling table for at least one additional controlled table, and wherein data change events are fired for each at least one additional controlled table using unique identifiers retrieved for its corresponding controlling table.

5. The method as recited in claim 1, wherein the item selected is a row of the controlling table and the unique identifier is related to a column of the selected row.

6. The method as recited in claim 1, wherein the selecting of an item is performed by a user.

7. The method as recited in claim 1, wherein the selecting of an item is performed automatically using a predetermined item before enabling user selection of an item.

8. The method as recited in claim 7, said method further comprising:
selecting, by a user, a second item of the controlling table, the second item defining a second unique identifier;
repeating the steps of:
setting a query variable for each of the at least one controlled table, wherein the query variable is related to the second unique identifier;
firing a data change event for each of the at least one controlled table;
running queries for each of the at least one controlled table using query variables set in the setting step;
rendering data for each of the at least one controlled table, wherein the rendered data in the at least one controlled table is related to data in the controlling table; and
enabling user selection of a new item in a controlling table.

9. A computer system for selecting rows displayed in a layout of a graphical user interface (GUI) where the action of selecting a row results in the display of related data, said computer system comprising:
a module comprising a GUI running on a computing device capable of executing object-oriented computer programs;
a first section of object oriented computer code defining a layout schema for the GUI, the schema comprising class definitions for a table class, a table connection class, a table controller connection class, a data event class and a data listener interface, wherein the table controller connection class identifies at least one table controlled by a controlling table; and
a second section of object-oriented computer code defining instances of the classes defined in the layout schema, whereby responsive to selection of a row in a controlling table, the data listener interface fires an event which results in related data being displayed in at least one controlled table.

10. The computer system as recited in claim 9, wherein a plurality of relationships between the GUI and layout of desired controlling tables and controlled tables are modifiable in a text file.

11. A memory for storing data for access by a graphical user interface (GUI) application program being executed on a data processing system, wherein the GUI allows selection of rows displayed in a layout of the GUI, where the action of selecting a row results in the display of related data, comprising:
an object-oriented class schema stored in a first memory, wherein the class schema comprises class definitions for a table class, a table connection class, a table controller connection class, a data event class and a data listener interface, wherein the table controller connection class identifies at least one table controlled by a controlling table; and
an object oriented data structure stored in a second memory, the data structure comprising a plurality of class instances corresponding to classes defined in the class schema, whereby relationships between the GUI application program and layout of desired controlling tables and controlled tables enables selection of a row in a controlling table to result in populating at least one controlled table with data related to data in the controlling table.

12. The memory for storing data as recited in claim 11, wherein data in the second memory are inputs to the GUI upon launching of the GUI application program, thereby avoiding recompilation of the GUI application program when data in the second memory is modified.

13. A computer system for selecting data items displayed in a layout of a graphical user interface (GUI) where the action of selecting a data item results in the display of related data, said computer system comprising:
a module comprising a GUI running on a computing device capable of executing object-oriented computer programs;
a first section of object oriented computer code defining a layout schema for the GUI, the schema comprising class definitions a controlling data item class, a data item connection class, a data item controller connection class, a data event class and a data listener interface, wherein the data item connection class identifies at least one data item controlled by a controlling data item; and
a second section of object-oriented computer code defining instances of the classes defined in the layout schema, wherein a plurality of relationships between the GUI and layout of desired controlling data items and controlled data items enables selection of an item in a set of controlling data items to result in populating at least one controlled set of data items with data related to data in the controlling set of data items.

14. A method for selecting a data item displayed in a layout of a graphical user interface where the action of selecting a data item results in the display of related data, comprising:
creating a data item view for a controlling data item;
attaching a data listener to the controlling data item;
rendering data in the controlling data item;
selecting a corresponding item of the controlling data item, the corresponding item defining a unique identifier of the controlling data item;
setting a query variable for each of the at least one controlled data item, wherein the query variable is related to the unique identifier;
firing a data change event, to be received by the data listener, for each of the at least one controlled data item;
running queries using the query variable set for at least one controlled data item; and
rendering data for at least one controlled data item, wherein the rendered data in the at least one controlled data item is related to data in the controlling data item.
